(19) United States
(12) Patent Application Publication
(10) Pub. No.: US 2024/0070660 A1
(43) Pub. Date: Feb. 29, 2024

(54) NON-FUNGIBLE TOKENS (NFTS) FOR MANAGEMENT OF VIRTUAL ASSETS

(71) Applicants: SONY GROUP CORPORATION, Tokyo (JP); SONY INTERACTIVE ENTERTAINMENT LLC, San Mateo, CA (US)

(72) Inventors: JAMES R MILNE, RAMONA, CA (US); TRUE XIONG, SAN DIEGO, CA (US); CHARLES MCCOY, SAN DIEGO, CA (US)

(21) Appl. No.: 17/894,036

(22) Filed: Aug. 23, 2022

(51) Int. Cl. G06Q 20/38

(52) U.S. Cl. CPC G06Q 20/389

(57) ABSTRACT

An electronic device and method for implementation of non-fungible tokens (NFTs) for management of virtual assets is disclosed. The electronic device tracks a virtual asset associated with a user on a virtual reality platform and receives metadata associated with the virtual asset. A first NFT associated with the virtual asset is created, based on a storage of the metadata to a distributed ledger associated with the virtual reality platform. The first NFT is split into a set of NFTs. Each NFT is associated with a user-right corresponding to the virtual asset for the first user. The set of NFTs is stored on the distributed ledger. From the set of NFTs, a second NFT associated with the first virtual asset is retrieved, based on a user input. An ownership or usage of the virtual asset is controlled on the virtual reality platform, based on the second NFT.

This application makes reference to U.S. application Ser. No. 17/893,990 (Attorney Docket No. SYP347705US01US), which was filed on Aug. 23, 2022. This application also makes reference to U.S. application Ser. No. ______ (Attorney Docket No. SYP347705US03US), which was filed on Aug. 23, 2022. The above stated patent applications are hereby incorporated herein by reference in their entirety

### FIELD

Various embodiments of the disclosure relate to non-fungible tokens (NFTs). More specifically, various embodiments of the disclosure relate to an electronic device and method for implementation of NFTs for management of virtual assets.

### BACKGROUND

Advancements in computer-simulation technology have led to development of virtual reality platforms. A virtual reality platform may generate a virtual environment through which a user may interact with virtual assets (or virtual objects) in the virtual environment. The virtual environment may correspond to a computer-simulated three-dimensional (3D) environment including the virtual assets and an avatar of the user. For example, the virtual reality platform may correspond to a gaming platform including one or more gaming applications. The gaming platform may simulate a virtual environment associated with each of the one or more gaming applications to provide the user with a realistic experience when the user plays the one or more gaming applications. With the proliferation of the virtual reality platforms, management of the virtual assets of the virtual reality platforms to cater to diverse needs of the users may be a non-trivial task.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for implementation of non-fungible tokens (NFTs) for management of virtual assets is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for implementation of non-fungible tokens (NFTs) for management of virtual assets, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for implementation of non-fungible tokens (NFTs) for management of virtual assets on virtual reality platforms, in accordance with an embodiment of the disclosure.

FIG. 4 is a diagram that illustrates an exemplary processing pipeline for transfer of user-rights associated with virtual assets between two virtual reality platforms, in accordance with an embodiment of the disclosure.

FIG. 5 is a diagram that illustrates an exemplary processing pipeline for user profile based ownership or usage control of virtual assets, in accordance with an embodiment of the disclosure.

FIG. 6 is a diagram that illustrates an exemplary processing pipeline for destruction of a set of non-fungible tokens (NFTs) associated with a virtual asset based on a destruction of the virtual asset on a virtual reality (VR) platform, in accordance with an embodiment of the disclosure.

FIG. 7 is a diagram that illustrates an exemplary processing pipeline for implementation of non-fungible tokens (NFTs) to trade gaming assets across gaming applications, in accordance with an embodiment of the disclosure

FIG. 8 is a flowchart that illustrates operations of an exemplary method for implementation of non-fungible tokens (NFTs) for management of virtual assets on virtual reality platforms, in accordance with an embodiment of the disclosure.

### DETAILED DESCRIPTION

The following described implementation may be found in the electronic device and method for implementation of non-fungible tokens (NFTs) for management of virtual assets. Exemplary aspects of the disclosure may provide an electronic device that may implement non-fungible tokens (NFTs) for management of virtual assets. The electronic device may track a first virtual asset associated with a first user on a first virtual reality platform. For example, the first virtual reality platform may correspond to a gaming application, such as, a virtual sports game. The first virtual asset may be a gaming asset, such as, a virtual sports equipment, in an example. Further, the electronic device may receive metadata associated with the tracked first virtual asset. Examples of the metadata associated with the first virtual asset (such as, a virtual sports equipment) may include, but are not limited to, properties, a shape, a color, or a power associated with the first virtual asset. Further, the electronic device may create a first NFT associated with the tracked first virtual asset. The first NFT may be created based on a storage of the received metadata to a first distributed ledger associated with the first virtual reality platform. An NFT may correspond to a non-interchangeable and non-fungible unit of data representative of a digital asset that may be stored on a distributed ledger. Further, the electronic device may split the created first NFT into a set of NFTs. Each NFT of the set of NFTs may be associated with a corresponding user-right associated with the first virtual asset for the first user. The set of NFTs may be stored on the first distributed ledger. Examples of the user-right may include, but are not limited to, an ownership right, a modification right, a renting right, a time-share right, or a derivative creation right. The electronic device may further retrieve, from the set of NFTs, a second NFT associated with the tracked first virtual asset based on a user input from the first user. The retrieved second NFT may correspond to a certain user-right (e.g., a modification right) associated with the first virtual asset. Further, the electronic device may control an ownership or a usage of the tracked first virtual asset on the first virtual reality platform, based on the retrieved second NFT. In an example, if the retrieved second NFT corresponds to the modification right, the electronic device may control the ownership or usage of the first virtual asset to provide modification rights for the first virtual asset to the first user.

Typically, a virtual reality platform may be associated with multiple virtual assets, which may be difficult to manage due to a large number of users and various types of operations that may be feasible on each virtual asset. The disclosed electronic device may create an NFT (e.g., the first NFT) for each virtual asset (e.g., the tracked first virtual asset) of a user (e.g., the first user). The created NFT (e.g., the first NFT) may be stored on a distributed ledger (e.g., the first distributed ledger). Further, the created NFT (e.g., the first NFT) may be split into the set of NFTs. Each NFT in the set of NFTs may correspond to a user-right associated with the virtual asset. The set of NFTs may also be stored on the distributed ledger. To grant a certain user-right to the user for the virtual asset, the electronic device may retrieve, from the set of NFTs, an NFT (e.g., the second NFT) corresponding to the particular user-right. Thereafter, the user may be provided with the particular user-right for the virtual asset. Thus, the disclosed electronic device may control multiple types of user-rights associated with the virtual asset, based on corresponding NFTs associated with the user-rights for the virtual asset. For example, the user may be granted an ownership right with respect to a virtual asset but may not be granted a modification right with respect to the same virtual asset. In another scenario, one user may be granted ownership right for a virtual asset and another user may be granted only rental rights for the virtual asset. Hence, the ownership or usage rights of virtual assets associated with a virtual reality platform may be granularly controlled and effectively managed.

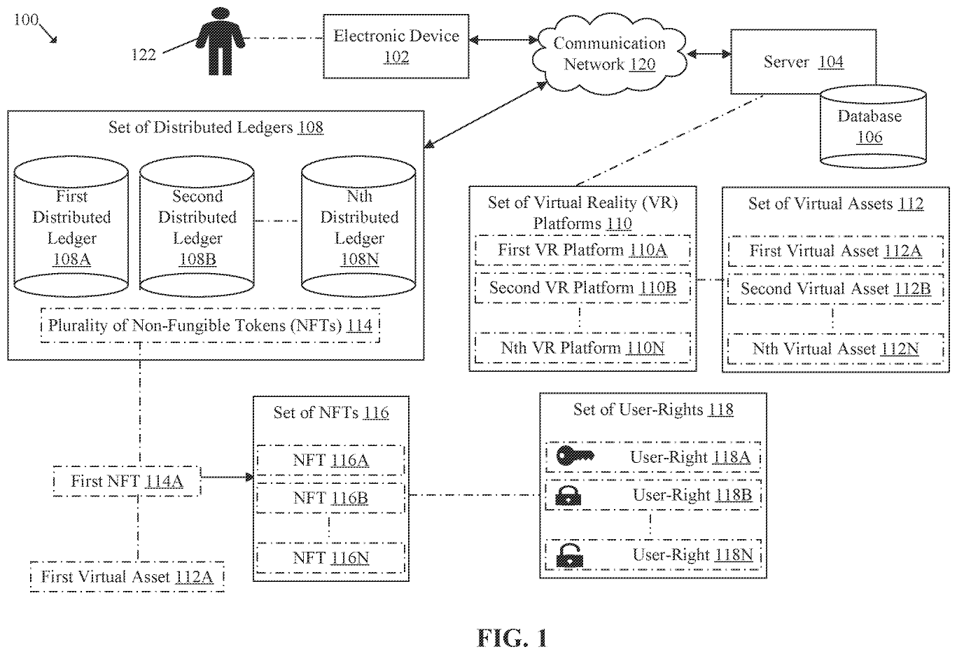

FIG. 1 is a block diagram that illustrates an exemplary network environment for implementation of non-fungible tokens (NFTs) for management of virtual assets, in accordance with an embodiment of the disclosure. With reference to FIG. 1, there is shown a network environment 100. The network environment 100 may include an electronic device 102, a server 104, a database 106, a set of distributed ledgers 108, and a communication network 120. The electronic device 102, the server 104, and the set of distributed ledgers 108 may be communicatively coupled to one another, via the communication network 120. The server 104 may include a set of virtual reality (VR) platforms 110. The set of VR platforms 110 may include ‘N’ number of VR platforms, such as, a first VR platform 110A, a second VR platform 110B, . . . and an Nth VR platform 110N. Each of the set of VR platforms 110 may be associated with a set of virtual assets 112. The set of virtual assets 112 may include ‘N’ number of virtual assets, such as, a first virtual asset 112A, a second virtual asset 112B, . . . and an Nth virtual asset 122N. The set of distributed ledgers 108 may include ‘N’ number of distributed ledgers, such as, a first distributed ledger 108A, a second distributed ledger 108B, . . . and an Nth distributed ledger 108N. The set of distributed ledgers 108 may store a plurality of NFTs 114. The plurality of NFTs 114 may include a first NFT 114A and one or more other NFTs (not shown). The first NFT 114A may be associated with the first virtual asset 112A. In FIG. 1, there is further shown a set of NFTs 116. The set of NFTs 116 may include ‘N’ number of NFTs, such as, an NFT 116A, an NFT 116B, . . . and an NFT 116N. The set of NFTs 116 may be associated with a set of user-rights 118, which may include ‘N’ number of user-rights, such as, a user-right 118A, a user-right 118B, . . . and a user-right 118N. In FIG. 1, there is further shown a user 122 (e.g., a first user), who may be associated with or operate the electronic device 102.

The N number of the distributed ledgers, VR platforms, virtual assets, NFTs, and user-rights shown in FIG. 1 are presented merely as an example. Each of the set of distributed ledgers 108, the set of VR platforms 110, the set of virtual assets 112, the set of NFTs 116, and the set of user-rights 118 may include only one or more than N respective components, without deviation from the scope of the disclosure. For the sake of brevity, only N components of each of the distributed ledgers, VR platforms, virtual assets, NFTs, and user-rights are shown in FIG. 1. However, in some embodiments, there may be more than N components of each of the distributed ledgers, VR platforms, virtual assets, NFTs, and user-rights, without limitation of the scope of the disclosure.

The electronic device 102 may include suitable logic, circuitry, interfaces, and/or code that may be configured to track a first virtual asset (e.g., the first virtual asset 112A) associated with a first user (e.g., the user 122) on a first virtual reality platform (e.g., the first VR platform 110A). Further, the electronic device 102 may receive metadata associated with the tracked first virtual asset 112A. and create a first NFT (e.g., the first NFT 114A) associated with the tracked first virtual asset 112A. The first NFT 114A may be created based on a storage of the received metadata to a first distributed ledger (e.g., the first distributed ledger 108A) associated with the first VR platform 110A. Further, the electronic device 102 may split the created first NFT 114A into a set of NFTs (e.g., the set of NFTs 116). Each NFT of the set of NFTs may be associated with a corresponding user-right (e.g., a user-right from the set of user-rights 118) associated with the first virtual asset 112A for the first user (e.g., the user 122). The set of NFTs 116 may be stored on the first distributed ledger 108A. Examples of the user-right may include, but are not limited to, an ownership right, a modification right, a renting right, a time-share right, or a derivative creation right. From the set of NFTs 116, the electronic device 102 may retrieve an NFT (e.g., a second NFT, not shown in FIG. 1) related to a certain user-right (of the set of user-rights 118). Accordingly, the electronic device 102 may control an ownership or a usage of the tracked first virtual asset 112A on the first VR platform 110A, based on the retrieved second NFT. In an example, if the retrieved second NFT corresponds to the modification right, the electronic device 102 may control the ownership or usage of the first virtual asset 112A to provide modification rights for the first virtual asset 112A to the first user (e.g., the user 122).

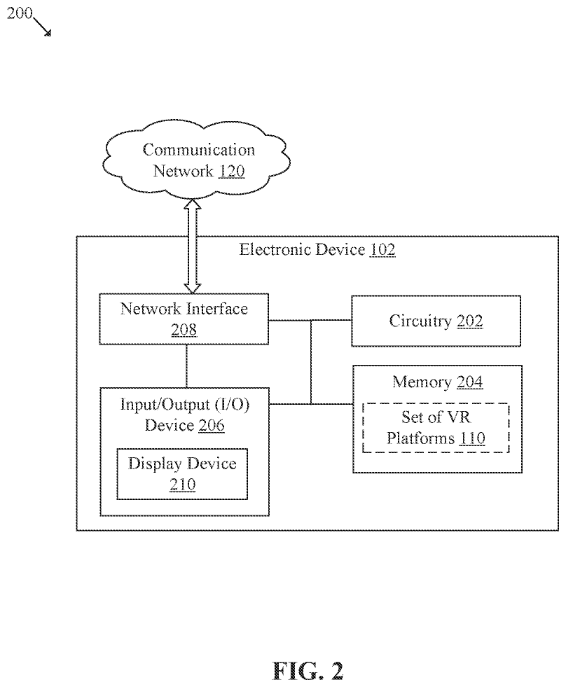

Though the set of VR platforms 110 is shown as associated with or hosted on the server 104 in FIG. 1, in some embodiments, the set of VR platforms 110 may be implemented on the electronic device 102, without a departure from the scope of the disclosure. For example, information related to the set of VR platforms 110 and the set of virtual assets 112 may be stored on the electronic device 102 (for example, in a memory 204 of FIG. 2) instead of, or in addition to, the server 104 or the database 106.

Examples of the electronic device 102 may include, but are not limited to, a computing device, a smartphone, a cellular phone, a mobile phone, a gaming device, a gaming console, a smart television (TV), an augmented reality (AR)/virtual reality (VR)/mixed reality (MR) device, a head-mounted display (HMD) for gaming, a heads-up display (HUD) for gaming, smart glasses for gaming, a mainframe machine, a server, a computer workstation, and/or a consumer electronic (CE) device.

The server 104 may include suitable logic, circuitry, and interfaces, and/or code that may be configured to implement or host the set of VR platforms 110 and store information associated with the set of virtual assets 112. The server 104 may be configured to create the first NFT 114A based on a storage of the metadata, associated with the first virtual asset 714A, to the first distributed ledger 108A associated with the first VR platform 110A. Further, the server 104 may be configured to split the created first NFT 114A into the set of NFTs 116. The server 104 may be configured to control the ownership or usage of the first virtual asset 112A, with respect to a certain user-right, based on a retrieval of an NFT (from the set of NFTs 116) corresponding to the particular user-right. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store information associated with the set of VR platforms 110, the set of virtual assets 112, and the metadata associated with the first virtual asset 112A. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device that stores the database 106 may be configured to receive a query for the information stored on the database 106. Based on the received query, the device of the database 106 may be configured to retrieve and provide the queried information to the electronic device 102 (or the server 104). In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

Each of the set of distributed ledgers 108 may be a decentralized and distributed database system that may maintain an immutable record of data operations or transactions such as, the plurality of NFTs 114 and the set of NFTs 116. A set of data operations may be grouped together as a block and may be further linked to a previous block of data operations to form a chain of a plurality of blocks. All blocks of data operations may be stored in a decentralized manner, whereby all participants or nodes store all the plurality of blocks. Further, each of the set of distributed ledgers 108 may include an operating system which may allow for deployment of the group of smart contracts between multiple parties, for example, the user 122 and the electronic device 102. In some implementations, different nodes of each of the set of distributed ledgers 108 may be owned and/or operated by different entities, such as, businesses or individuals. In some implementations, all of the nodes of the set of distributed ledgers 108 may be owned and/or operated by a single entity, such as a VR platform, a game publisher, or game platform provider. Each of the set of distributed ledgers 108 may be a chain of blocks which uses accounts as state objects such that a state of each account may be tracked by the chain. The accounts represent identities of users, mining nodes, or automated agents. All the blocks of data operations or the smart contract are associated with the accounts on the chain of blocks.

By way of example, and not limitation, the set of distributed ledgers 108 may be an Ethereum blockchain which may use accounts as state objects such that a state of each account may be tracked by the Ethereum blockchain. The accounts represent identities of users, mining nodes, or automated agents. All the blocks of data operations or the smart contract are associated with the accounts on the Ethereum Blockchain. The scope of the disclosure may not be limited to the implementation of the set of distributed ledgers 108 as the Ethereum blockchain. Other implementations of the set of distributed ledgers 108 may be possible (for example, a Hyperledger blockchain or a Corda blockchain) in the present disclosure, without a deviation from the scope of the present disclosure.

Each of the set of VR platforms 110 may include logic, circuitry, and interfaces, and/or code that may be configured to generate a virtual environment through which a user (e.g., the user 122) may interact with virtual assets (e.g., the set of virtual assets 112) in the virtual environment. The virtual environment may correspond to a computer-simulated three-dimensional (3D) environment including the virtual assets (e.g., the set of virtual assets 112) and an avatar of the user 122. In an embodiment, the VR platform may correspond to one or more platforms that may enable players to play games in a virtual environment using, for example, a game console, or a mobile, a personal computer, a gaming system, or a 3D immersive systems, such as, VR headsets. In certain scenarios, the VR platform may be proprietary to games from a particular company, while in other cases, the VR platform may be open to include games from multiple companies. For example, a virtual reality platform (e.g., the first VR platform 110A) may correspond to a gaming platform including one or more gaming applications. The gaming platform may simulate a virtual environment associated with each of the one or more gaming applications to provide the user 122 with a realistic experience, when the user 122 plays the one or more gaming applications. A virtual asset (e.g., a sports equipment) may be a digital object that may be represented virtually in a VR platform (e.g., a sports virtual game).

In an embodiment, each of the set of VR platforms 110 may be associated with a corresponding distributed ledger of the set of distributed ledgers 108. For example, the first VR platform 110A may be associated with the first distributed ledger 108A, while the second VR platform 110B may be associated with the second distributed ledger 108B, and so on. In an embodiment, the set of VR platforms 110 may be implemented or hosted on the server 104. Additionally, or alternatively, the set of VR platforms 110 may be implemented or hosted on the electronic device 102. In such case, information related to the set of VR platforms 110 and the set of virtual assets 112 may be stored on a memory (e.g., a memory 204 of FIG. 2) of the electronic device 102.

The communication network 120 may include a communication medium through which the electronic device 102, the server 104, and the set of distributed ledgers 108 may communicate with one another. The communication network 120 may be one of a wired connection or a wireless connection. Examples of the communication network 120 may include, but are not limited to, the Internet, a cloud network, Cellular or Wireless Mobile Network (such as, Long-Term Evolution and 5th Generation (5G) New Radio (NR)), a satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 120 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

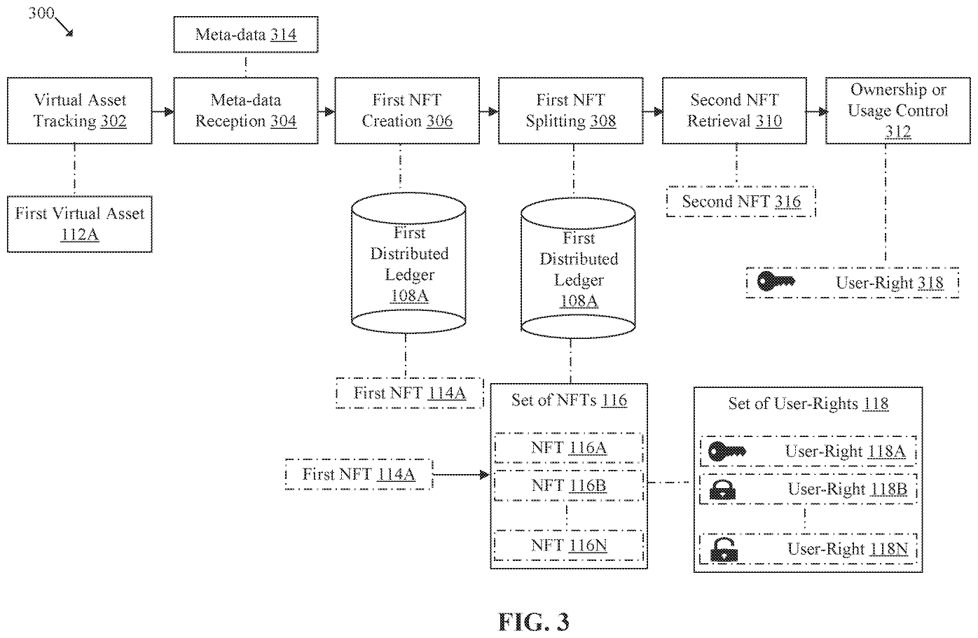

In operation, the electronic device 102 may be configured to track a first virtual asset (e.g., the first virtual asset 112A) associated with a first user (e.g., the user 122) on a first virtual reality platform (e.g., the first VR platform 110A). For example, the first VR platform 110A may be a gaming application and the first virtual asset 112A may be a gaming asset, which may be a tool to play the gaming application effectively. For example, the gaming application may be an application that may be used to play virtual games on electronic devices such as, a computer, a mobile phone, or a game console. For example, the gaming application may be an archery gaming application and the gaming asset may be an archery arrow. The gaming asset may be tracked in the gaming application. Details related to tracking of the first virtual asset are provided, for example, in FIG. 3.

The electronic device 102 may be configured receive metadata associated with the tracked first virtual asset 112A. The metadata may include attributes associated with the tracked first virtual asset 112A. In an example, the first VR platform 110A may be an archery game and the metadata may include a name of the tracked first virtual asset 112A (for example, a gaming asset, such as, a fast arrow) and an attribute of the tracked first virtual asset 112A may be a poisonous head, and the like. Details related to the metadata associated with the tracked first virtual asset are further provided, for example, in FIG. 3.

The electronic device 102 may be configured to create a first NFT (e.g., the first NFT 114A) associated with the tracked first virtual asset 112A. The first NFT 114A may be created based on a storage of the received metadata to a first distributed ledger (e.g., the first distributed ledger 108A) associated with the first VR platform 110A. It may be appreciated that an NFT may be a non-interchangeable and non-fungible unit of data representative of a digital asset, that may be stored on a distributed ledger (such as, the first distributed ledger 108A). For example, in order to create the first NFT 114A, the metadata including attributes (such as, the name “fast arrow”, and the attribute “poisonous”) of the first virtual asset 112A (e.g., the arrow) may be stored on the first distributed ledger 108A, such as, including one or more blockchain nodes. Details related to the creation of the first NFT are provided, for example, in FIG. 3.

The electronic device 102 may be configured to split the created first NFT 114A into a set of NFTs (e.g., the set of NFTs 116). Each NFT of the set of NFTs may be associated with a corresponding user-right (e.g., a user-right from the set of user-rights 118) associated with the first virtual asset 112A for the first user (e.g., the user 122). The set of NFTs 116 may be stored on the first distributed ledger 108A. Examples of the user-right may include, but are not limited to, an ownership right, a modification right, a renting right, a time-share right, or a derivative creation right. Details related to the splitting of the created first NFT are further provided, for example, in FIG. 3.

The electronic device 102 may be configured to retrieve an NFT (e.g., a second NFT, not shown in FIG. 1) related to a certain user-right (of the set of user-rights 118). Accordingly, the electronic device 102 may control an ownership or a usage of the tracked first virtual asset 112A on the first VR platform 110A, based on the retrieved second NFT. In an example, if the retrieved second NFT corresponds to the modification right, the electronic device 102 may control the ownership or usage of the first virtual asset 112A to provide modification rights for the first virtual asset 112A to the first user (e.g., the user 122). Details related to the retrieval of the second NFT and the control of the ownership or usage of the first virtual asset are further provided, for example, in FIG. 3.

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, and a network interface 208. The memory 204 may include information related to the set of VR platforms 110, and the input/output (I/O) device 206 may include a display device 210. The network interface 208 may connect the electronic device 102 with the set of distributed ledgers 108 and the server 104, via the communication network 120.

The circuitry 202 may include suitable logic, circuitry, and/or interfaces that may be configured to execute program instructions associated with different operations to be executed by the electronic device 102. The operations may include first virtual asset tracking, metadata reception, first NFT creation, first NFT splitting, second NFT retrieval, and ownership or usage control of the first virtual asset 112A. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute different operations of the circuitry 202 (and/or the electronic device 102). The memory 204 may be configured to store information related to the set of VR platforms 110. Further, the memory 204 may store information related to the set of virtual assets 112 and the metadata associated with the first virtual asset 112A. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a user input indicative of a selection of a VR platform and a virtual asset by the user 122. The user input may further include a selection of a user-right associated with the selected virtual asset that may be required to be enabled or disabled. The I/O device 206 may be further configured to display a user-interface associated with the set of VR platforms 110 and the selected virtual asset. The I/O device 206 may include various input and output devices, which may be configured to communicate with the circuitry 202. The I/O device 206 may include the display device 210. Examples of the I/O device 206 may include, but are not limited to, a touch screen, the display device 210, a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102, the set of distributed ledgers 108, and the server 104. The network interface 208 may be implemented by use of various known technologies to support wired or wireless communication of the electronic device 102 with the communication network. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display the user-interface associated with the set of VR platforms 110 and the tracked first virtual asset 112A. The display device 210 may be a touch screen which may enable a user (e.g., the user 122) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for implementation of NFTs for management of virtual assets on virtual reality platforms are described further, for example, in FIGS. 3, 4, 5, 6 and 7.

FIG. 3 is a diagram that illustrates an exemplary processing pipeline for implementation of non-fungible tokens (NFTs) for management of virtual assets on virtual reality platforms, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 312 for implementation of gaming assets as NFTs. The exemplary operations 302 to 312 may be executed by any computing system, for example, by the electronic device 102 of FIG. 1 or by the circuitry 202 of FIG. 2. The exemplary processing pipeline 300 further illustrates the first virtual asset 112A, metadata 314, the first distributed ledger 108A, the first NFT 114A, the set of NFTs 116, the set of user-rights 118, a second NFT 316, and a user-right 318.

At 302, a virtual asset tracking operation may be executed. The circuitry 202 may be configured to track a virtual asset (e.g., the first virtual asset 112A) associated with a first user (e.g., the user 122) on the first VR platform 110A. For example, the first virtual asset 112A may correspond to a gaming asset and the first VR platform 110A may correspond to a gaming application. It may be appreciated the gaming asset may correspond to a tool that may help a player to play the gaming application effectively. The gaming application may be an application that may be used to play virtual games on electronic devices such as, a computer, a mobile phone, a smart television (TV), a gaming console, smart glasses, or a virtual reality (VR)/augmented reality (AR) headset, and the like. The player (e.g., the first user) such as, the user 122 of FIG. 1, may use the gaming asset when the player plays the gaming application. In an example, the gaming application may be a football gaming application, and the gaming asset may be a football, a certain type of shoes, a dress/jersey, an accessory of a footballer, and the like. In another example, the gaming application may be a vehicle racing gaming application, and the gaming asset may be a four-wheeler such as, a red car. In such case, a plurality of vehicles along with the red car may participate in a race. The player may use one or more controls to move the red car in the vehicle racing gaming application. The vehicle that reaches an end point first may be ranked with a first position. The plurality of vehicles along with the red car may be tracked throughout the race to determine insights such as, ranks, points, levels, powers earned, and the like, for the player. In another example, the gaming application may correspond to a virtual fighting gaming application where two or more players may fight against each other and the player that defeats other players may be regarded as a winner. In such case, the gaming asset may be a weapon used for the fight. The use of weapons may be tracked in such gaming application.

In an embodiment, the gaming asset may correspond to at least one of the weapon, a gun, an avatar, a costume, an accessory, a vehicle, a character, a prop, a player status, or a gaming tool. In case of a fighting gaming application, a weapon may be used by the players to fight against each other. Examples of the weapon may include, but are not limited to, a basic sword, a magic sword, an axe, a gun, a stick, a rope, a chain, and the like. The gun may be used in the gaming applications such as, shooting games, mystery games, and the like. Examples of the gun may include, but is not limited to, a machine gun, an assault rifle, a shotgun, a snipper gun, and the like. The avatar may be a character that may represent the player in the gaming application. For example, the gaming application may be a running gaming application where the player may run along a track to earn points and gems. The avatar may be an icon or character that may represent the player that may run along the track. The costume may be an outfit that may be associated with the icon of the gaming application. The use of costume may enrich player experience, provide certain powers associated with the costume, and the like. The accessory may be an extra item associated with the icon. For example, the accessory may be a hat that may be associated with the avatar. The vehicle may include two-wheeler vehicles or four-wheeler vehicles that may be used in the gaming application. The character may be a person in the gaming application. The prop may engage the player and may enrich gaming experience. The gaming tool may help the player to play the gaming application. The gaming asset may change according to the gaming application. For example, the gaming asset for a racing game may be the vehicle. Similarly, the gaming asset for the virtual fighting gaming application may be the weapon or the costume. In some implementations, the gaming asset may be customized by the player. For example, a player may specify aspects of the gaming asset such as size, shape, style, appearance, configurations, and attachments. In some implementations, the gaming asset may change as it is used in game play. For example, a player may upgrade the asset, use expendable units in the asset, reload expendable units in the asset, change attachments, or modify the appearance. A player status may include metadata about the player, such as a membership card for a particular guild, associated with the player in a gaming application. For example, the player status may indicate that a player achieved a goal, unlocked a power or a gaming asset, or is a member of group. The player status may also include game state information, such as an indication that the player befriended or angered a particular non-player character (or computer controlled character) in the game.

In another example, the first VR platform 110A may correspond to a virtual reality world including a virtual land or virtual estate as virtual assets. A user (e.g., the first user, such as, the user 122) may own a virtual estate as a virtual asset, such as, the first virtual asset 112A. The first virtual asset 112A may have associated user-rights (such as, the user-right 118A). Examples of the user-rights may include, but are not limited to, construction rights for the virtual estate, renting rights for the virtual estate, mineral extraction or mining rights for the virtual estate, air rights to construct multi-storied virtual buildings up to a certain height, break building codes or zoning ordinances, underground rights for the virtual estate, or rights to block flights over the virtual estate.

At 304, a metadata reception operation may be executed. The circuitry 202 may be configured to receive metadata (e.g., the metadata 314) associated with the tracked first virtual asset 112A. The metadata 314 may provide details associated with the tracked first virtual asset 112A. In an example, the first VR platform 110A may be a gaming application, such as, a football gaming application and the tracked first virtual asset 112A may be a gaming asset, such as, a football. In such case, the metadata 314 may include properties of the tracked first virtual asset 112A (i.e., the gaming asset). The metadata 314 may include a name of the gaming asset, which is the football, a color of the gaming asset (e.g., white). In an embodiment, the reception of the metadata 314 may be triggered based on various conditions, such as, but not limited to, when the player clears a level of the gaming application, periodically after a predefined time interval of gameplay, or based on a user input of the player to save the game and create a save-point or checkpoint in the gaming application. In another example, the first VR platform 110A may correspond to a virtual reality world including a virtual land or virtual estate as virtual assets. A user (e.g., the first user, such as, the user 122) may own a virtual estate as a virtual asset, such as, the first virtual asset 112A. In such case, the metadata 314 associated with the first virtual asset 112A (i.e., the virtual estate) may include, but is not limited to, an area associated with the virtual estate, dimensions of the virtual estate, a geographical region associated with the virtual estate, and a cost associated with the virtual estate.

At 306, a first NFT creation operation may be executed. The circuitry 202 may be configured to create the first NFT (e.g., the first NFT 114A), associated with the tracked first virtual asset 112A, based on the received metadata 314. The first NFT 114A may be created based on a storage of the received metadata 314 to a first distributed ledger (e.g., the first distributed ledger 108A) associated with the first virtual reality platform (e.g., the first VR platform 110A). It may be appreciated that an NFT (e.g., the first NFT 114A) may be a non-interchangeable and non-fungible unit of data that may be stored on a distributed ledger (e.g., the first distributed ledger 108A). Examples of the data unit associated with NFTs may include, but are not limited to, photos, videos, audio files, documents, gaming assets, virtual estates, and other digital assets. The NFT may be traded and the owner of the NFT or the buyer of the NFT may have rights over the NFT. For example, if the tracked first virtual asset 112A is a football and the metadata 314 associated with the football includes a shape (such as, circular), a color (such as, white), and a name (such as, a football), then the circuitry 202 may store the aforesaid metadata 314 of the football to the first distributed ledger 108A.

At 308, a first NFT splitting operation may be executed. The circuitry 202 may be configured to split the created first NFT (e.g., the first NFT 114A) into a set of NFTs (e.g., the set of NFTs 116, such as, the NFT 116A, the NFT 116B, . . . and the NFT 116N). Each NFT of the set of NFTs 116 may be associated with a corresponding user-right associated with the first virtual asset 112A. The set of NFTs 116 may be stored on the first distributed ledger 108A. For example, the set of NFTs 116 may be associated with the set of user-rights 118. The NFT 116A may be associated with the user-right 118A, the NFT 1168 may be associated with the user-right 118B, . . . and the NFT 116N may be associated with the user-right 118N. Examples of the set of user-rights 118 may include, but are not limited to, an ownership right, a modification right, a renting right, a time-share right, or a derivative creation right. For example, the user-right 118A (corresponding to the NFT 116A) may be associated with an ownership right of the first virtual asset 112A, while the user-right 118B (corresponding to the NFT 116B) may be associated with a modification right of the first virtual asset 112A. The ownership right associated with a virtual asset may be a right of a user to possess the virtual asset subject to certain conditions. For example, the user may be allowed to possess the virtual asset with or without a right to rent out or modify the ownership right. The modification right associated with a virtual asset may be a right of a user to modify the virtual asset, irrespective of whether the user has an ownership right, or a renting right associated with the virtual asset. The renting right may allow a virtual asset and an associated NFT (e.g., the NFT 116A) to be rented to a user for a certain period of time. When the NFT 116A is rented, the user to whom the NFT 116A is rented may have ownership rights over the first virtual asset 112A, while the original owner of the first virtual asset 112A may not. In certain cases, a portion of the first virtual asset 112A (e.g., a fraction of a total area of a virtual estate) may be rented. In such case, the NFT 116A may correspond to a fungible or a non-fungible token. The time-share right may allow a user to share an ownership of a virtual asset with another user on a time-shared basis for a certain time period, such that at any point of time in the given time period only one of the users may possess and/or use the virtual asset. The derivative creation right may allow a user a right to create a new virtual asset, based on the first virtual asset 112A. For example, an original virtual asset may be a digital art created by an artist. Based on the derivative creation right on the virtual asset, the user may embed the digital art in an electronic brochure to create a derived digital art. In certain cases, the creator of the derivative work may be a partial owner of the derivative work, along with the artist of the original work. Thus, separate NFTs may be created to grant separate user-rights associated with the first virtual asset 112A to one or more users. Hence, for a certain virtual asset (e.g., the first virtual asset 112A), a first right (e.g., the ownership right) may be assigned to one user and a second right (e.g., the modification right) may be assigned to another user, based on a transfer of the corresponding NFTs (such as, the NFT 116A and the NFT 1168, respectively) to the respective users.

In an embodiment, the first virtual asset 112A may be partially owned by a plurality of users. In such case, each user of the plurality of users may own a predefined portion (e.g., an equal share) of the first virtual asset 112A. The first virtual asset 112A may be concurrently used by one or more of the plurality of users on the first virtual reality platform. In such case, an NFT (e.g., the first NFT 114A) associated with the first virtual asset 112A may be a fungible token or a non-fungible token. For example, a virtual asset, such as, a virtual estate in the first VR platform 110A may be owned by three users, such that each of the three users may own 33.33% of the share of the virtual estate. Thus, the virtual estate may be used concurrently by any or all of the three owners of the virtual estate. In an embodiment, the plurality of users, who partially own the first virtual asset 112A, may include the first user. In such case, the first user may also own a portion of the first virtual asset 112A along with other users in the plurality of users. In another embodiment, the plurality of users, who partially own the first virtual asset 112A, may not include the first user. In such case, the first user may not own any portion of the first virtual asset 112A.

In an embodiment, a semi-fungible token may be associated with the tracked first virtual asset 112A on the first VR platform 110A. The semi-fungible token may correspond to a predefined number of copies of the first virtual asset 112A on the first VR platform 110A. For example, a game asset may include a digital collectible, such as, a scroll or a painting, as an in-game content that may be owned by players of a gaming application (i.e., a VR platform). A limited number of the digital collectible artifacts or assets may be created for the gaming application and auctioned or earned by the players during game-play. For example, 100 copies of the digital collectible may be created. A player may own at most N copies (e.g., 1 copy) of the digital collectible. Also, there may be a maximum of at most M players (e.g., 100 players) who may own the digital collectible concurrently. Further, each copy of the digital collectible (and associated NFT) may be uniquely numbered (such as, 15 of 100). The digital collectible may be represented by a semi-fungible token and each copy of the digital collectible may be represented as an NFT.

At 310, an operation to retrieve a second NFT may be executed. The circuitry 202 may be configured to retrieve a second NFT (e.g., the second NFT 316) associated with the tracked first virtual asset 112A, based on a user input from the first user (e.g., the user 122). The first distributed ledger 108A may include the set of NFTs 116 stored in the first distributed ledger 108A. The circuitry 202 may receive a user input indicative of a request to enable a certain user-right associated with the first virtual asset 112A in the first VR platform 110A. For example, the user-input may indicate that the user 122 may wish to enable/purchase modification rights associated with a certain virtual asset (such as, a virtual estate). The circuitry 202 may determine an NFT from the set of NFTs 116 that may be associated with the user-rights that may be required to be enabled/purchased. For example, the circuitry 202 may determine that the second NFT 316 may be associated with a user-right (e.g., the user-right 318) that may be requested by the user 122. The circuitry 202 may retrieve the second NFT 316 from the set of NFTs 116 stored on the first distributed ledger 108A. The circuitry 202 may request the first distributed ledger 108A for the second NFT 316. The first distributed ledger 108A may verify whether the request of the circuitry 202 is legitimate or not, and may further retrieve and transmit the retrieved second NFT 316 to the circuitry 202, based on the verification.

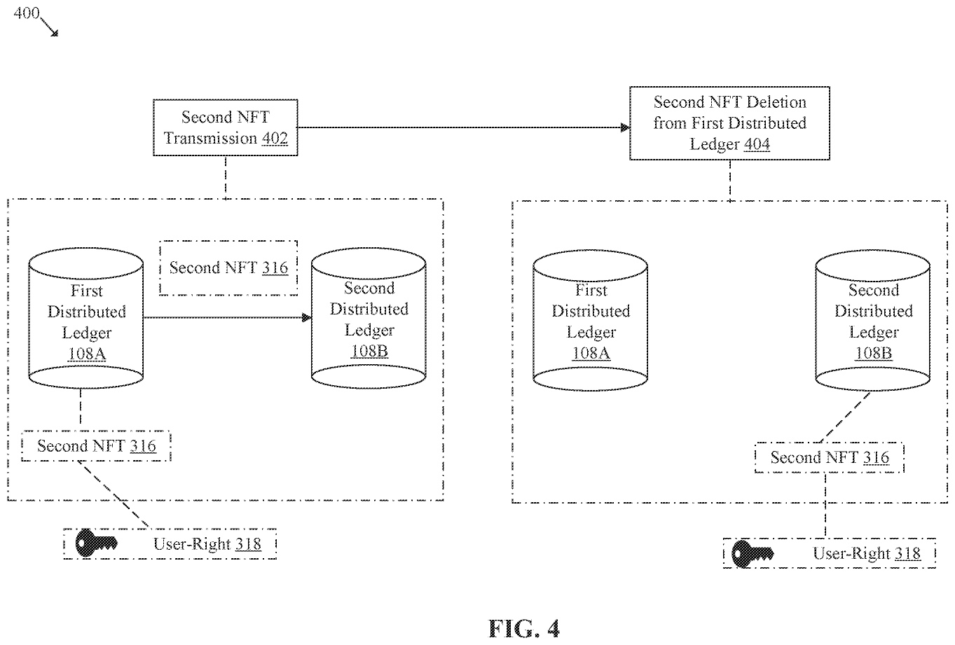

At 312, an ownership or usage control operation may be executed. The circuitry 202 may be configured to control an ownership or a usage of the tracked first virtual asset 112A on the first VR platform 110A, based on the retrieved second NFT 316. Once the second NFT 316 is retrieved, the circuitry 202 may control the ownership or usage of the tracked first virtual asset 112A, based on the user-right (e.g., the user-right 318) associated with the second NFT 316. For example, the second NFT 316 may be associated with the user-right 318, which may provide rental rights associated with the tracked first virtual asset 112A (e.g., a virtual estate). Based on the retrieval of the second NFT 316, the circuitry 202 may control the ownership or usage of the tracked first virtual asset 112A (e.g., the virtual estate) to provide rental rights (i.e., associated with the virtual estate) to the user 122 on the first VR platform 110A. Details related to the management of virtual assets based on NFTs are described further, for example, in FIGS. 4, 5, 6, and 7.

Typically, a virtual reality platform may be associated with multiple virtual assets, which may be difficult to manage due to a large number of users and various types of operations that may be feasible on each virtual asset. The disclosed electronic device 102 may create an NFT (e.g., the first NFT 114A) for each virtual asset (e.g., the tracked first virtual asset 112A) of a user (e.g., the first user, such as, the user 122). The created NFT (e.g., the first NFT 114A) may be stored on a distributed ledger (e.g., the first distributed ledger 108A). Further, the created NFT (e.g., the first NFT 114A) may be split into the set of NFTs 116. Each NFT in the set of NFTs 116 may correspond to a user-right associated with the virtual asset. The set of NFTs 116 may also be stored on the distributed ledger. To grant a certain user-right to the user 122 for the virtual asset, the electronic device 102 may retrieve, from the set of NFTs 116, an NFT (e.g., the second NFT 316) corresponding to the particular user-right (e.g., the user-right 318). Thereafter, the user 122 may be provided with the particular user-right (e.g., the user-right 318) for the virtual asset (e.g., a virtual estate). Thus, the disclosed electronic device 102 may control multiple types of user-rights associated with the virtual asset, based on corresponding NFTs associated with the user-rights for the virtual asset. For example, the user 122 may be granted an ownership right with respect to a virtual asset but may not be granted a modification right with respect to the same virtual asset. In another scenario, one user may be granted ownership right for a virtual asset and another user may be granted only rental rights for the virtual asset. Hence, the ownership or usage rights of virtual assets associated with a virtual reality platform may be granularly controlled and effectively managed.

FIG. 4 is a diagram that illustrates an exemplary processing pipeline for transfer of user-rights associated with virtual assets between two virtual reality platforms, in accordance with an embodiment of the disclosure. FIG. 4 is explained in conjunction with elements from FIG. 1, FIG. 2, and FIG. 3. With reference to FIG. 4, there is shown an exemplary processing pipeline 400 that illustrates exemplary operations from 402 to 404 for transfer of user-rights associated with virtual assets between two virtual reality platforms. The exemplary operations 402 to 404 may be executed by any computing system, for example, by the electronic device 102 of FIG. 1 or by the circuitry 202 of FIG. 2. The exemplary processing pipeline 400 further illustrates the first distributed ledger 108A, the second distributed ledger 1088, the second NFT 316, and the user-right 318.

At 402, an operation to transmit the second NFT may be executed. In an embodiment, the circuitry 202 may be configured to transmit the retrieved second NFT (e.g., the second NFT 316) to a second distributed ledger (e.g., the second distributed ledger 108B) different from the first distributed ledger (e.g., the first distributed ledger 108A). The circuitry 202 may retrieve the second NFT 316 from the set of NFTs 116 stored on the first distributed ledger 108A. For example, the circuitry 202 may request the first distributed ledger 108A for the second NFT 316. The first distributed ledger 108A may verify whether the request of the circuitry 202 is legitimate or not, and may further retrieve and transmit the retrieved second NFT 316 to the circuitry 202, based on the verification. The retrieved second NFT 316 may be associated with a user-right (e.g., the user-right 318), such as, a modification right associated with the first virtual asset 112A. Once the second NFT 316 is retrieved from the first distributed ledger 108A, the circuitry 202 may transmit the retrieved second NFT 316 to the second distributed ledger 1088 for storage. In some embodiments, the circuitry 202 may request the first distributed ledger 108A to directly transfer the second NFT 316 to the second distributed ledger 108B for storage. In such case, the first distributed ledger 108A may transmit the second NFT 316 to the second distributed ledger 108B, based on the request received from the circuitry 202.

At 404, an operation to delete the second NFT from the first distributed ledger may be executed. In an embodiment, the circuitry 202 may be configured to delete the transmitted second NFT (e.g., the second NFT 316) from the first distributed ledger 108A. Once the second NFT 316 is transmitted to the second distributed ledger 108B, the second NFT 316 may be stored on the second distributed ledger 108B. Further, the second NFT 316 may be deleted from the first distributed ledger 108A, based on the storage of the second NFT 316 on the second distributed ledger 1088. The circuitry 202 may control the deletion of the second NFT 316 from the first distributed ledger 108A. In an embodiment, both the first distributed ledger 108A and the second distributed ledger 108B may be associated with the same virtual reality platform (such as, the first VR platform 110A).

In an embodiment, the first distributed ledger 108A may be associated with the first VR platform 110A and the second distributed ledger 1088 may be associated with the second VR platform 1108. The second VR platform 1108 may be different from the first VR platform 110A. In an embodiment, the transfer of the second NFT 316 from the first distributed ledger 108A to the second distributed ledger 108B may correspond to a transfer of user-rights associated with the second NFT 316 from the first VR platform 110A to the second VR platform 1108. For example, based on the storage of the second NFT 316 on the second distributed ledger 1088 and based on the deletion of the second NFT 316 from the first distributed ledger 108A, the user-right 318 associated with the second NFT 316 may be transferred from the first VR platform 110A to the second VR platform 1108. Thus, user-rights of virtual assets may be migrated between two VR platforms, which may provide flexible granular management of the user-rights associated with the virtual assets. For example, the ownership rights of a virtual asset may be available on a first virtual reality platform, while the modification rights of the virtual asset may be available on a second virtual reality platform. In an example, a first user may have the ownership rights of a virtual asset on the first VR platform 110A, while a second user may have the modification rights of the virtual asset on the second VR platform 1108. In another example, the first user may have the ownership rights and the modification rights of the virtual asset. The ownership rights to the virtual asset may be available on the first VR platform 110A, while the modification rights to the virtual asset may be available on the second VR platform 1108.

Though, the migration of the user-right is described with respect to two VR platforms, the scope of the disclosure may not be so limited. The user-rights may be migrated across more than two VR platforms, without departure from the scope of the disclosure.

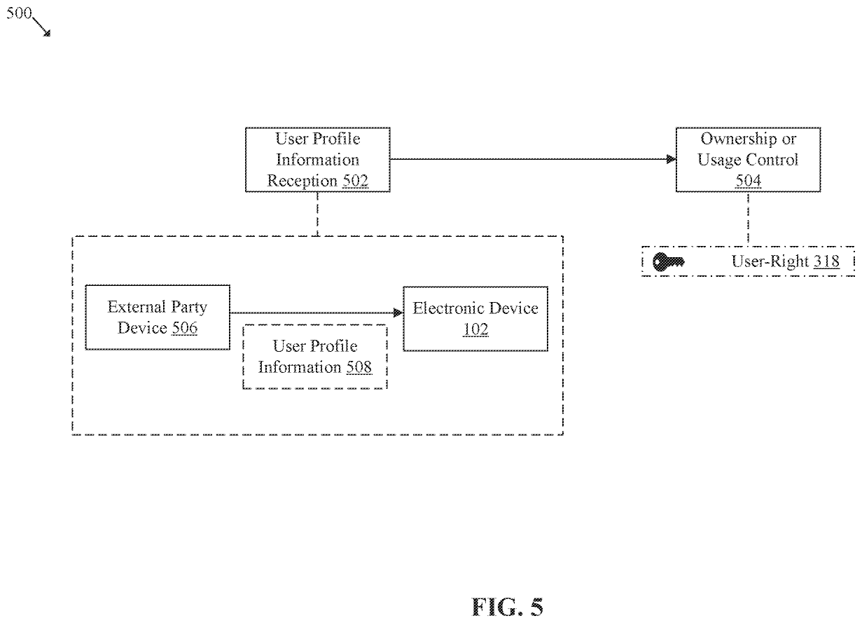

FIG. 5 is a diagram that illustrates an exemplary processing pipeline for user profile based ownership or usage control of virtual assets, in accordance with an embodiment of the disclosure. FIG. 5 is explained in conjunction with elements from FIG. 1, FIG. 2, FIG. 3, and FIG. 4. With reference to FIG. 5, there is shown an exemplary processing pipeline 500 that illustrates exemplary operations from 502 to 504 for user profile based ownership or usage control of virtual assets. The exemplary operations 502 to 504 may be executed by any computing system, for example, by the electronic device 102 of FIG. 1 or by the circuitry 202 of FIG. 2. The exemplary processing pipeline 500 further illustrates an external party device 506, user profile information 508, the electronic device 102, and the user-right 318.

At 502, a user profile information reception operation may be executed. In an embodiment, the circuitry 202 may be configured to receive user profile information (e.g., the user profile information 508) of the first user (e.g., the user 122) from an external party (e.g., via the external party device 506) associated with the first VR platform 110A. For example, the external party may correspond to a third party or an affiliate of the first VR platform 110A. Multiple affiliates of each VR platform (e.g., the first VR platform 110A) may maintain user accounts including information related to user profiles of users associated to the corresponding affiliates. The circuitry 202 may receive information related to the user profile (e.g., the user profile information 508 associated with the user 122) from one or more such affiliates (e.g., via the external party device 506). The received user profile information 508 may include details including, but not limited to, an account of the user 122 with the affiliate, a set of virtual assets (e.g., the first virtual asset 112A) owned by the user 122, a set of user-rights (e.g., the set of user-rights 118) associated with the set of virtual assets, and an identification of VR platforms on which the user 122 may be registered. The user profile maintained by each affiliate may include an affiliate name that may be used to divide an account identifier (ID) into different name spaces so that a combination of an affiliate ID and an account ID may identifies who the user who may own a virtual asset. The combination of affiliate ID and account ID may enable transfer of user-rights associated with a user from an account with one affiliate to an account with another affiliate.

At 504, an ownership or usage control operation may be executed. The circuitry 202 may be configured to control an ownership or a usage of a virtual asset (e.g., the first virtual asset 112A) on a VR platform (e.g., the first VR platform 110A), further based on the received user profile information 508. For example, the received user profile information 508 may include details related to a virtual asset associated with the user 122, a set of user-rights associated with the virtual asset, and an identification of a VR platform associated with the virtual asset. Once the user profile information 508 is received, the circuitry 202 may control the ownership or usage of the certain virtual asset associated with the user 122 on the identified VR platform, based on the set of user-rights (e.g., the user-right 318) associated with the particular virtual asset. For example, the user-right 318 may provide rental rights associated with the first virtual asset 112A (e.g., a virtual estate) on the first VR platform 110A. Based on the receipt of the user profile information 508, the circuitry 202 may control the ownership or usage of the first virtual asset 112A (e.g., the virtual estate) to provide rental rights associated with the virtual estate to the user 122. Thus, user-right management for virtual assets on multiple VR platforms may be managed across multiple affiliates of each VR platform based on accounts of users maintained by the corresponding affiliates. Also, in certain scenarios, a first user-right (e.g., a rental right) associated with a virtual asset on the first VR platform 110A may be accorded to a user based on the user's profile associated with a first affiliate of the first VR platform 110A. Further, a second user-right (e.g., a modification right) associated with the same virtual asset on the first VR platform 110A may be accorded to the same user (or another user) based on the user's profile (or the other user's profile) associated with a second affiliate of the first VR platform 110A. In another scenario, the second affiliate may be associated with the second VR platform 110B, and thus the user-rights associated with the virtual asset may be managed granularly for one or more users, across multiple VR platforms.

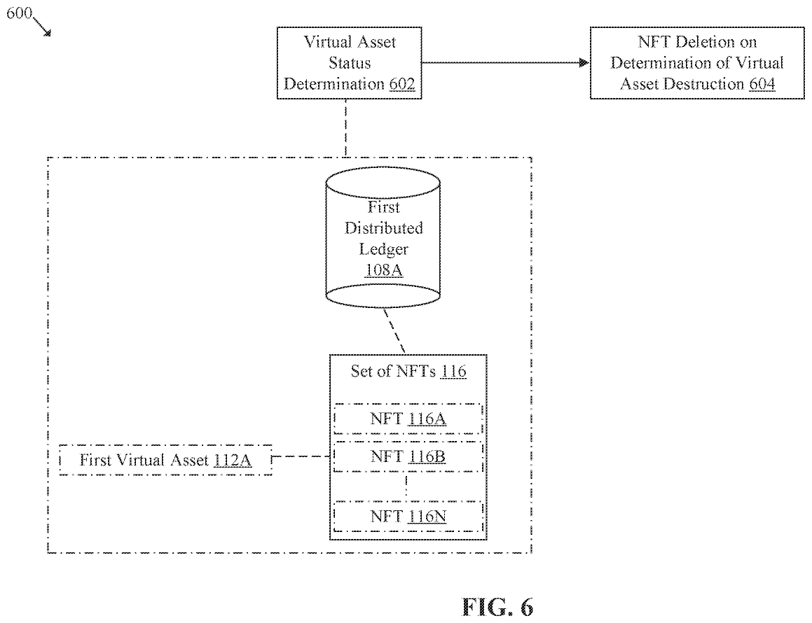

FIG. 6 is a diagram that illustrates an exemplary processing pipeline for destruction of a set of non-fungible tokens (NFTs) associated with a virtual asset based on a destruction of the virtual asset on a virtual reality (VR) platform, in accordance with an embodiment of the disclosure. FIG. 6 is explained in conjunction with elements from FIG. 1, FIG. 2, FIG. 3, FIG. 4, and FIG. 5. With reference to FIG. 6, there is shown an exemplary processing pipeline 600 that illustrates exemplary operations from 602 to 604 for destruction of a set of NFTs associated with a virtual asset based on a destruction of the virtual asset on VR platform. The exemplary operations 602 to 604 may be executed by any computing system, for example, by the electronic device 102 of FIG. 1 or by the circuitry 202 of FIG. 2. The exemplary processing pipeline 600 further illustrates the first distributed ledger 108A, the first virtual asset 112A, and the set of NFTs 116.

At 602, a virtual asset status determination operation may be executed. In an embodiment, the circuitry 202 may be configured to track a virtual asset (e.g., the first virtual asset 112A) associated with a first user (e.g., the user 122) to determine a status of the virtual asset on a VR platform (e.g., the first VR platform 110A). Based on the tracking of the first virtual asset 112A, the circuitry 202 may determine whether the tracked first virtual asset associated with the first user on the first VR platform 110A is destroyed. For example, the first VR platform 110A may correspond to a gaming application, such as, a running game. The first virtual asset 112A may correspond to a gaming asset, such as, a hat. The hat may have a property that the hat may be consumed once the player is defeated in a level or once the player dies in the running game. The gaming application may track the progress of the player and the gaming asset through the game and may detect when the player is defeated, or the player dies in the game. Based on the progress tracking, the gaming application may determine that the hat has been consumed, and thereby destroyed in the gaming application.

At 604, an NFT deletion operation may be executed based on determination of a virtual asset destruction. In an embodiment, the circuitry 202 may be configured to delete the set of NFTs 116 associated with the tracked first virtual asset 112A, based on the determination that the tracked first virtual asset 112A is destructed/destroyed. Based on the tracking of the first virtual asset 112A (at 602), if the circuitry 202 determines that the tracked first virtual asset 112A is destroyed on the first VR platform 110A, the circuitry 202 may be configured to delete the set of NFTs 116 associated with the tracked first virtual asset 112A. On the deletion of the set of NFTs 116, each of the set of NFTs 116 may be removed from the first distributed ledger 108A. Thus, the destruction of a virtual asset on a VR platform may trigger the deletion of a corresponding NFT stored on a distributed ledger associated with the VR platform. The deletion of the corresponding NFT may also render the user-rights associated with the NFT unusable by the user who may previously own the virtual asset. Thus, based on the tracking of the virtual assets of a user on a VR platform, the user-rights of the virtual assets may be managed and controlled such that a destruction of a virtual asset on the VR platform may disable the user-rights of the virtual asset for the user on the VR platform.

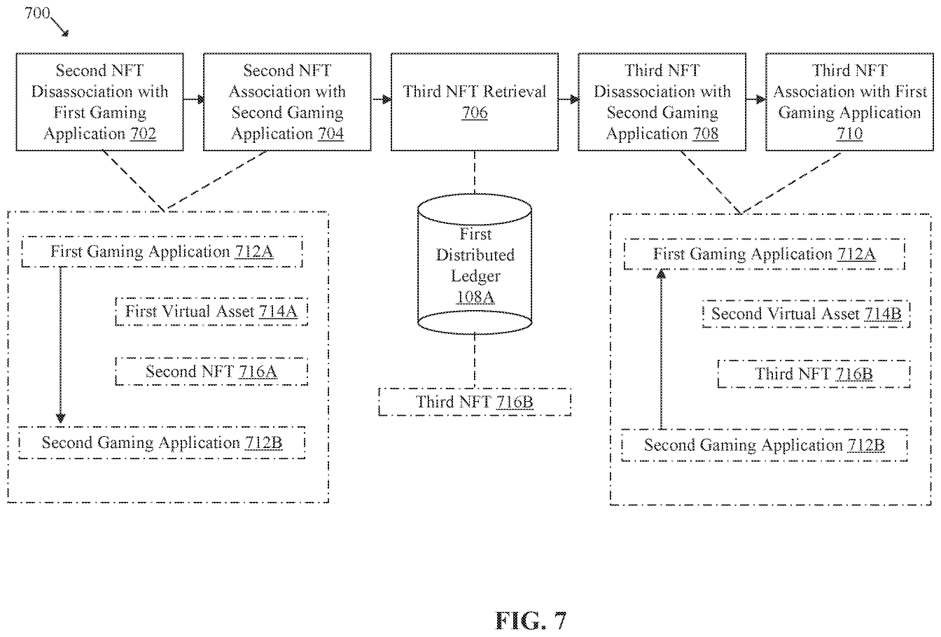

FIG. 7 is a diagram that illustrates an exemplary processing pipeline for implementation of non-fungible tokens (NFTs) to trade gaming assets across gaming applications, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown an exemplary processing pipeline 700 that illustrates exemplary operations from 702 to 710 for implementation of NFTs to trade gaming assets across gaming applications. The exemplary operations 702 to 710 may be executed by any computing system, for example, by the electronic device 102 of FIG. 1 or by the circuitry 202 of FIG. 2. The exemplary processing pipeline 700 further illustrates the first distributed ledger 108A, a first gaming application 712A, a second gaming application 7128, a first virtual asset 714A, a second virtual asset 7148, a second NFT 716A, and a third NFT 7168.

At 702, an operation to disassociate a second NFT with a first gaming application may be executed. In an embodiment, the circuitry 202 may be configured to disassociate the retrieved second NFT (retrieved at 310 of FIG. 3), associated with the tracked first virtual asset (e.g., the first virtual asset 714A), from a first gaming application (e.g., the first gaming application 712A) of a set of gaming applications. In an embodiment, the first VR platform 110A may correspond to a gaming platform including the set of gaming applications. The set of gaming application may include games, such as, but not limited to, the first gaming application 712A and the second gaming application 712B, as shown in FIG. 7. In an embodiment, the first gaming application 712A may be different from the second gaming application 7128.

In another embodiment, the first gaming application 712A may be the same as the second gaming application 712B. In such case, at least one of a mode, a level, an environment, or a player type associated with the first gaming application 712A may be different from the second gaming application 712B. Examples of a mode of a gaming application may include, but is not limited to, a Christmas mode, a spring mode, a dark mode, a tournament mode, a classic mode, and the like. The modes may provide enriched gaming experience to the player as the gaming application may become monotonous if the same mode is played throughout. In an example, the gaming application may be a vehicle racing gaming application and the various modes may be the Christmas mode, the spring mode, and the classic mode. In another example, the various modes may correspond to a difficulty level of the gaming application, like an easy mode, a medium mode, a high mode, or an expert mode.

In an example, the gaming application may include a plurality of levels. For example, if the gaming application is the fighting gaming application, then the gaming application may include certain number of levels, such as, two hundred levels. The player may reach the next level based on a victory against system generated opponents in preceding levels. With each level, the system generated opponents may fight with the player with greater intensity.

In an embodiment, the environment of the gaming application may correspond to a background of the gaming application. For example, the gaming application may be a running gaming application and the environment may be spring, sunny, cloudy, and the like. The player may select the environment (such as, the sunny environment) of the gaming application when the player plays the game.

In an example, the type of the player may be a computer, a person, an auto generated player, and the like. It may be noted that the type of the player may vary from game to game. In multi-player games, the types of players may vary. In an example, a gaming application may be a chess gaming application and the user 122 may play against the computer (i.e., a first type of player). However, in case the chess gaming application enables the user 122 to play against another human player, the type of player may be a human player (i.e., a second type of player).

The first user (e.g., the user 122) may wish to trade a virtual asset (e.g., the first virtual asset 714A) of the first gaming application 712A against another virtual asset (e.g., the second virtual asset 714B) of the second gaming application 712B. The second NFT 716A may be associated with the first virtual asset 714A. To trade the virtual asset (e.g., the first virtual asset 714A) of the first gaming application 712A against the other virtual asset (e.g., the second virtual asset 714B) of the second gaming application 712B, the circuitry 202 may disassociate the second NFT 716A from the first gaming application 712A. Based on the dissociation of the second NFT 716A from the first gaming application 712A, the first virtual asset 714A may no longer be available to the first user (e.g., the user 122) in the first gaming application 712A

At 704, an operation to associate the second NFT with a second gaming application may be executed. In an embodiment, the circuitry 202 may be configured to associate the retrieved second NFT (retrieved at 310 of FIG. 3), associated with the tracked first virtual asset (e.g., the first virtual asset 714A), with a second gaming application (e.g., the second gaming application 712B) of the set of gaming applications. The second NFT 716A may be associated with the first virtual asset 714A. To trade the first virtual asset 714A of the first gaming application 712A against the second virtual asset 714B of the second gaming application 712B, the circuitry 202 may disassociate the second NFT 716A from the first gaming application 712A, as described at 704. Once the second NFT 716A is disassociated from the first gaming application 712A, the circuitry 202 may associate the second NFT 716A with the second gaming application 712B. The disassociation of the second NFT 716A from the first gaming application 712A and the association of the second NFT 716A with the second gaming application 712B may transfer the second NFT 716A from the first gaming application 712A to the second gaming application 712B. Consequently, the tracked first virtual asset 714A associated with the second NFT 716A may also be transferred from the first gaming application 712A to the second gaming application 712B. The second NFT 716A may correspond to a user-right associated with the first virtual asset 714A. Such user-right (e.g., an ownership right) associated with the first virtual asset 714A may also be transferred from the first gaming application 712A to the second gaming application 712B, based on the transfer of the second NFT 716A from the first gaming application 712A to the second gaming application 712B.

At 706, an operation to retrieve a third NFT may be executed. The circuitry 202 may be configured to retrieve a third NFT (e.g., the third NFT 716B) associated with a second virtual asset (e.g., the second virtual asset 714B) in the second gaming application (e.g., the second gaming application 712B). In an embodiment, the third NFT 716B may be associated with a second user different from the first user. In another embodiment, the third NFT 716B may be associated with the same user as the user of the second NFT 716A. For example, both the second NFT 316 (as shown in FIG. 3) and the third NFT 716B may be associated with the first user.

Based on the disassociation of the second NFT 716A from the first gaming application 712A and the association of the second NFT 716A with the second gaming application 712B, the second NFT 716A may be transferred from the first gaming application 712A to the second gaming application 712B. Consequently, the first virtual asset 714A associated with the second NFT 716A may also be transferred from the first gaming application 712A to the second gaming application 712B. The circuitry 202 may determine an NFT (e.g., the third NFT 716B) associated with the second virtual asset 714B, which may be required to be traded against the first virtual asset 714A. The first distributed ledger 108A may include the set of NFTs 116 stored in the first distributed ledger 108A. The circuitry 202 may retrieve the third NFT 716B from the set of NFTs 116 stored on the first distributed ledger 108A. The circuitry 202 may request the first distributed ledger 108A for the third NFT 716B. The first distributed ledger 108A may verify whether the request of the circuitry 202 is legitimate or not, and may further retrieve and transmit the retrieved third NFT 716B to the circuitry 202, based on the verification.

At 708, an operation to disassociate a third NFT with a second gaming application may be executed. In an embodiment, the circuitry 202 may be configured to disassociate the retrieved third NFT 716B (retrieved at 706), associated with the second virtual asset (e.g., the second virtual asset 714B), from a second gaming application (e.g., the second gaming application 712B) of a set of gaming applications. The retrieved third NFT 716B may be associated with the second virtual asset 714B. To trade the first virtual asset 714A of the first gaming application 712A against the second virtual asset 714B of the second gaming application 712B, the circuitry 202 may further disassociate the third NFT 716B from the second gaming application 712B. Based on the dissociation of the third NFT 716B from the second gaming application 712B, the second virtual asset 714B may no longer be available to the user 122 (such as, the first user or a second user) in the second gaming application 7128.

At 710, an operation to associate the third NFT 716B with a first gaming application may be executed. In an embodiment, the circuitry 202 may be configured to associate the retrieved third NFT 716B (retrieved at 706), associated with the second virtual asset (e.g., the second virtual asset 714B), with a first gaming application (e.g., the first gaming application 712A) of the set of gaming applications. The third NFT 7168 may be associated with the second virtual asset 7148. To trade the first virtual asset 714A of the first gaming application 712A against the second virtual asset 714B of the second gaming application 7128, the circuitry 202 may disassociate the third NFT 7168 from the second gaming application 712B, as described at 708. Once the third NFT 716B is disassociated from the second gaming application 7128, the circuitry 202 may associate the third NFT 7168 with the first gaming application 712A. The disassociation of the third NFT 7168 from the second gaming application 7128 and the association of the third NFT 716B with the first gaming application 712A may transfer the third NFT 716B from the second gaming application 7128 to the first gaming application 712A. Consequently, the second virtual asset 714B associated with the third NFT 716B may also be transferred from the second gaming application 7128 to the first gaming application 712A. The third NFT 7168 may correspond to a user-right associated with the second virtual asset 7148. Such user-right (e.g., a modification right) associated with the second virtual asset 714B may also be transferred from the second gaming application 712B to the first gaming application 712A, based on the transfer of the third NFT 716B from the second gaming application 712B to the first gaming application 712A. Thus, two virtual assets and corresponding user-rights may be traded between two gaming applications by transfer of NFTs associated with the virtual assets between the gaming applications. Also, as the disclosed electronic device 102 may implement individual user-rights associated with the virtual assets based on corresponding NFTs, granular control of an ownership or usage of the virtual assets across the gaming application may be achieved. Hence, apart from the trade the virtual assets across the gaming applications, specific user-rights associated the virtual assets may also be traded across the gaming applications, based on the migration of corresponding NFTs across the gaming applications.

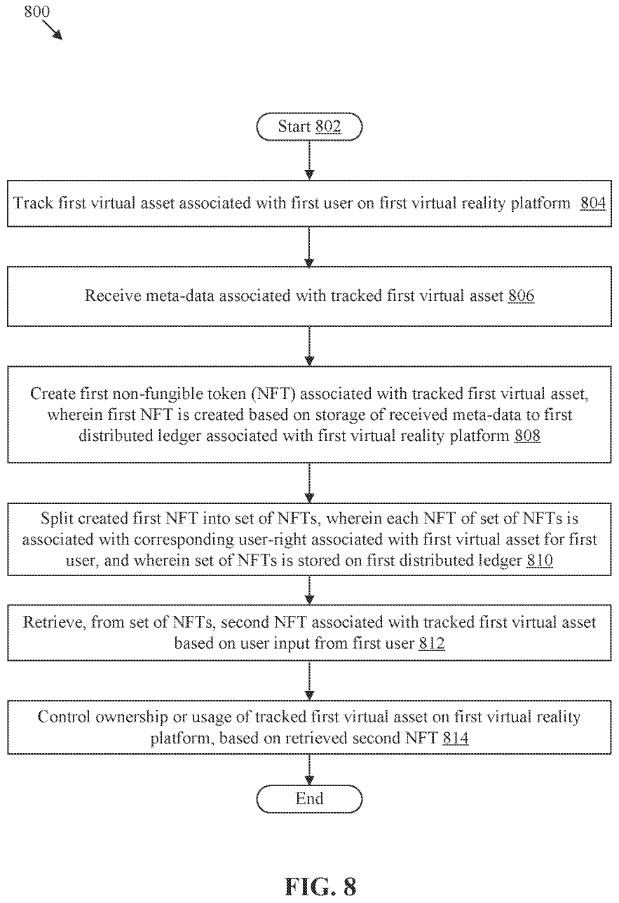

FIG. 8 is a flowchart that illustrates operations of an exemplary method for implementation of non-fungible tokens (NFTs) for management of virtual assets on virtual reality platforms, in accordance with an embodiment of the disclosure. FIG. 8 is described in conjunction with elements from FIG. 1, FIG. 2, FIG. 3, FIG. 4, FIG. 5, FIG. 6, and FIG. 7. With reference to FIG. 8, there is shown a flowchart 800. The flowchart 800 may include operations from 802 to 814 and may be implemented by the electronic device 102 of FIG. 1 or by the circuitry 202 of FIG. 2. The flowchart 800 may start at 802 and proceed to 804.

At 804, the first virtual asset 112A associated with the first user (e.g., the user 122) on the first VR platform 110A may be tracked. In an embodiment, the circuitry 202 may be configured to track the first virtual asset 112A associated with the first user on the first VR platform 110A. For example, the first virtual asset 112A may correspond to a gaming asset and the first VR platform 110A may correspond to a gaming application. The status of the gaming asset may be tracked as the first user (i.e., a player) may progress through the game. In another example, the first virtual asset 112A may correspond to a virtual estate and the first VR platform 110A may correspond to a virtual reality world. Each player of the virtual reality world may earn or buy one or more virtual estates in the virtual reality world. Further, each player may have certain user-rights (i.e., ownership or usage rights) associated with the one or more virtual estates associated with the player. The status of an ownership and development of the virtual estates and the associated user-rights may be tracked as the different players may play in the virtual reality world. The tracking of the first virtual assets is described further, for example, in FIG. 3 (at 302).

At 806, the metadata (e.g., the metadata 314) associated with the tracked first virtual asset 112A may be received. In an embodiment, the circuitry 202 may be configured to receive the metadata 314 associated with the tracked first virtual asset 112A. In an example, the first VR platform 110A may be a gaming application, such as, a football gaming application and the tracked first virtual asset 112A may be a gaming asset, such as, a football. In such case, the metadata 314 may include properties of the tracked first virtual asset 112A (i.e., the gaming asset). The metadata 314 may include a name of the gaming asset, which is the football, a color of the gaming asset (e.g., white). In an embodiment, the reception of the metadata 314 may be triggered based on various conditions, such as, but not limited to, when the player clears a level of the gaming application, periodically after a predefined time interval of gameplay, or based on a user input of the player to save the game and create a save-point or checkpoint in the gaming application. In another example, the first VR platform 110A may correspond to a virtual reality world including a virtual land or virtual estate as virtual assets. A user (e.g., the first user, such as, the user 122) may own a virtual estate as a virtual asset, such as, the first virtual asset 112A. In such case, the metadata 314 associated with the first virtual asset 112A (i.e., the virtual estate) may include, but is not limited to, an area associated with the virtual estate, dimensions of the virtual estate, a geographical region associated with the virtual estate, and a cost associated with the virtual estate.

At 808, the first NFT 114A associated with the tracked first virtual asset 112A may be created, wherein the first NFT 114A may be created based on a storage of the received metadata 314 to the first distributed ledger 108A associated with the first VR platform 110A. In an embodiment, the circuitry 202 may be configured to create the first NFT 114A associated with the tracked first virtual asset 112A. The first NFT 114A may be created based on the storage of the received metadata 314 to the first distributed ledger 108A associated with the first VR platform 110A. It may be appreciated that an NFT (e.g., the first NFT 114A) may be a non-interchangeable and non-fungible unit of data that may be stored on a distributed ledger (e.g., the first distributed ledger 108A). Examples of the data unit associated with NFTs may include, but are not limited to, photos, videos, audio files, documents, gaming assets, virtual estates, and other digital assets. The NFT may be traded and the owner of the NFT or the buyer of the NFT may have rights over the NFT. For example, if the tracked first virtual asset 112A is a football and the metadata 314 associated with the football includes a shape (such as, circular), a color (such as, white), and a name (such as, a football), then the circuitry 202 may store the aforesaid metadata 314 of the football to the first distributed ledger 108A.

At 810, the created first NFT 114A may be split into the set of NFTs 116, wherein each NFT of the set of NFTs 116 may be associated with a corresponding user-right (from the set of user-rights 118) associated with the first virtual asset 112A for the first user (for example, the user 122), and wherein the set of NFTs 116 may be stored on the first distributed ledger 108A. In an embodiment, the circuitry 202 may be configured to split the created first NFT 114A into the set of NFTs 116. Each NFT of the set of NFTs 116 may be associated with a corresponding user-right associated with the first virtual asset 112A for the first user (for example, the user 122). Further, the set of NFTs 116 may be stored on the first distributed ledger 108A. For example, the set of NFTs 116 may be associated with the set of user-rights 118. The NFT 116A may be associated with the user-right 118A, the NFT 1168 may be associated with the user-right 118B, . . . and the NFT 116N may be associated with the user-right 118N. Examples of the set of user-rights 118 may include, but are not limited to, an ownership right, a modification right, a renting right, or a derivative creation right. For example, the user-right 118A (corresponding to the NFT 116A) may be associated with an ownership right of the first virtual asset 112A, while the user-right 118B (corresponding to the NFT 116B) may be associated with a modification right of the first virtual asset 112A. Thus, separate NFTs may be created to grant separate user-rights associated with the first virtual asset 112A to one or more users. Hence, for a certain virtual asset (e.g., the first virtual asset 112A), a first right (e.g., the ownership right) may be assigned to one user and a second right (e.g., the modification right) may be assigned to another user, based on a transfer of the corresponding NFTs (such as, the NFT 116A and the NFT 1168, respectively) to the respective users. The splitting of the created first NFT 114A into the set of NFTs 116 is described further, for example, in FIG. 3 (at 308).

At 812, from the set of NFTs 116, the second NFT 316 associated with the tracked first virtual asset 112A may be retrieved, based on a user input from the first user (e.g., the user 122). In an embodiment, the circuitry 202 may be configured to retrieve the second NFT (e.g., the second NFT 316) associated with the tracked first virtual asset 112A, based on a user input from the first user. The first distributed ledger 108A may include the set of NFTs 116 stored in the first distributed ledger 108A. The circuitry 202 may receive a user input indicative of a request to enable a certain user-right associated with the first virtual asset 112A in the first VR platform 110A. For example, the user-input may indicate that the user 122 may wish to enable/purchase modification rights associated with a certain virtual asset (such as, a virtual estate). The circuitry 202 may determine an NFT from the set of NFTs 116 that may be associated with the user-rights that may be required to be enabled/purchased. For example, the circuitry 202 may determine that the second NFT 316 may be associated with a user-right (e.g., the user-right 318) that may be requested by the user 122. The circuitry 202 may retrieve the second NFT 316 from the set of NFTs 116 stored on the first distributed ledger 108A. The circuitry 202 may request the first distributed ledger 108A for the second NFT 316. The first distributed ledger 108A may verify whether the request of the circuitry 202 is legitimate or not and may retrieve and transmit the retrieved second NFT 316 to the circuitry 202, based on the verification.

At 814, the ownership or usage of the tracked first virtual asset 112A may be controlled on the first VR platform 110A, based on the retrieved second NFT 316. In an embodiment, the circuitry 202 may be configured to control the ownership or the usage of the tracked first virtual asset 112A on the first VR platform 110A, based on the retrieved second NFT 316. Once the second NFT 316 is retrieved, the circuitry 202 may control the ownership or usage of the tracked first virtual asset 112A, based on the user-right (e.g., the user-right 318) associated with the second NFT 316. For example, the second NFT 316 may be associated with the user-right 318, which may provide rental rights associated with the tracked first virtual asset 112A (e.g., a virtual estate). Based on the retrieval of the second NFT 316, the circuitry 202 may control the ownership or usage of the tracked first virtual asset 112A (e.g., the virtual estate) to provide rental rights associated with the virtual estate to the user 122 on the first VR platform 110A. Control may pass to end.

Although the flowchart 800 is illustrated as discrete operations, such as, 804, 806, 808, 810, 812, and 814, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102). Such instructions may cause the electronic device 102 to perform operations that may include tracking of a first virtual asset (e.g., the first virtual asset 112A) associated with a first user (e.g., the user 122) on a first virtual reality platform (e.g., the first VR platform 110A). The operations may further include reception of metadata (e.g., the metadata 314) associated with the tracked first virtual asset 112A. The operations may further include creation of a first non-fungible token (NFT) (e.g., the first NFT 114A) associated with the tracked first virtual asset 112A, based on the received metadata 314. The first NFT 114A may be created based on a storage of the received metadata 314 to a first distributed ledger (e.g., the first distributed ledger 108A) associated with the first VR platform 110A. The operations may further include splitting of the created first NFT 114A into a set of NFTs (e.g., the set of NFTs 116). Each NFT of the set of NFTs 116 may be associated with a corresponding user-right associated with the first virtual asset 112A for the first user (for example, the user 122). Further, the set of NFTs 116 may be stored on the first distributed ledger 108A. The operations may further include retrieval of a second NFT (e.g., the second NFT 316) associated with the first virtual asset 112A from the set of NFTs 116, based on a user input from the first user (e.g., the user 122). The operations may further include a control of an ownership or usage of the tracked first virtual asset 112A on the first VR platform 110A, based on the retrieved second NFT 316.

Exemplary aspects of the disclosure may provide an electronic device (such as, the electronic device 102 of FIG. 1) that includes circuitry (such as, the circuitry 202). The circuitry 202 may be configured to track a first virtual asset (e.g., the first virtual asset 112A) associated with a first user (e.g., the user 122) on a first virtual reality platform (e.g., the first VR platform 110A). The circuitry 202 may be further configured to receive metadata (e.g., the metadata 314) associated with the tracked first virtual asset 112A. The circuitry 202 may be further configured to create a first non-fungible token (NFT) (e.g., the first NFT 114A) associated with the tracked first virtual asset 112A. The first NFT 114A may be created based on a storage of the received metadata 314 to a first distributed ledger (e.g., the first distributed ledger 108A) associated with the first VR platform 110A. The circuitry 202 may be further configured to split the created first NFT into a set of NFTs (e.g., the set of NFTs 116). Each NFT of the set of NFTs 116 may be associated with a corresponding user-right associated with the first virtual asset 112A for the first user (for example, the user 122). Further, the set of NFTs 116 may be stored on the first distributed ledger 108A. The circuitry 202 may be further configured to retrieve, from the set of NFTs 116, a second NFT (e.g., the second NFT 316) associated with the tracked first virtual asset 112A based on a user input from the first user (e.g., the user 122). The circuitry 202 may be further configured to control an ownership or a usage of the tracked first virtual asset 112A on the first VR platform 110A, based on the retrieved second NFT 316. In an embodiment, the user-right may include at least one of an ownership right, a modification right, a renting right, a time-share right, or a derivative creation right.

In an embodiment, the circuitry 202 may be configured to transmit the retrieved second NFT 316 to a second distributed ledger (e.g., the second distributed ledger 1088) different from the first distributed ledger 108A. The circuitry 202 may be configured to delete the transmitted second NFT 316 from the first distributed ledger 108A. The transmitted second NFT is stored on the second distributed ledger 108B. In an embodiment, the second distributed ledger 108B may be is associated with the first VR platform 110A. In another embodiment, the second distributed ledger 1088 may be associated with a second virtual reality platform (e.g., the second VR platform 110B), and the second VR platform 1108 may be different from the first VR platform 110A. In an embodiment, the user-right associated with the first virtual asset 112A may be transferred from the first VR platform 110A to the second VR platform 1108, based on the storage of the second NFT 316 on the second distributed ledger 108B.

In an embodiment, the first virtual asset 112A may be partially owned by a plurality of users. Each user of the plurality of users may own a predefined portion of the first virtual asset 112A. Further, the first virtual asset 112A may be concurrently used by one or more of the plurality of users on the first VR platform 110A.

In an embodiment, the circuitry 202 may be configured to receive user profile information of the first user from an external party associated with the first VR platform 110A. The control of the ownership or the usage of the first virtual asset 112A may be further based on the received user profile information.

In an embodiment, the circuitry 202 may be configured to determine whether the tracked first virtual asset 112A associated with the first user on the first VR platform 110A is destroyed. The circuitry 202 may be configured to delete, from the first distributed ledger 108A, each NFT of the set of NFTs 116 associated with the tracked first virtual asset 112A, based on the determination that the tracked first virtual asset 112A is destroyed on the first VR platform 110A.

In an embodiment, a semi-fungible token may be associated with the tracked first virtual asset 112A on the first VR platform 110A. The semi-fungible token may correspond to a predefined number of copies of the first virtual asset 112A on the first VR platform 110A.

In an embodiment, the first VR platform 110A may correspond to a gaming platform including a set of gaming applications. In an embodiment, the circuitry 202 may be configured to disassociate the retrieved second NFT 316, associated with the tracked first virtual asset 112A, from a first gaming application of the set of gaming applications. Further, the circuitry 202 may be configured to associate the retrieved second NFT 316, associated with the tracked first virtual asset 112A, with a second gaming application of the set of gaming applications. The circuitry 202 may be further configured to retrieve, from the first distributed ledger 108A, a third NFT associated with a second virtual asset in the second gaming application. The circuitry 202 may be configured to disassociate the retrieved third NFT, associated with the second virtual asset, from the second gaming application. Further, the circuitry 202 may be configured to associate the retrieved third NFT, associated with the second virtual asset, with the first gaming application. In an embodiment, the third NFT may be associated with a second user different from the first user. In another embodiment, the third NFT may be associated with the first user.

In an embodiment, the first gaming application may be different from the second gaming application. In another embodiment, the first gaming application may be same as the second gaming application, and at least one of a mode, a level, an environment, or a player type associated with the first gaming application may be different from the second gaming application.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
track a first virtual asset associated with a first user on a first virtual reality platform;
receive metadata associated with the tracked first virtual asset;
create a first non-fungible token (NFT) associated with the tracked first virtual asset, wherein
the first NFT is created based on a storage of the received metadata to a first distributed ledger associated with the first virtual reality platform;
split the created first NFT into a set of NFTs, wherein
each NFT of the set of NFTs is associated with a corresponding user-right associated with the first virtual asset for the first user, and
the set of NFTs is stored on the first distributed ledger;
retrieve, from the set of NFTs, a second NFT associated with the tracked first virtual asset based on a user input from the first user; and
control an ownership or a usage of the tracked first virtual asset on the first virtual reality platform, based on the retrieved second NFT.

2. The electronic device according to claim 1, wherein the user-right includes at least one of an ownership right, a modification right, a renting right, a time-share right, or a derivative creation right.

3. The electronic device according to claim 1, wherein the circuitry is further configured to:
transmit the retrieved second NFT to a second distributed ledger different from the first distributed ledger; and
delete the transmitted second NFT from the first distributed ledger, wherein
the transmitted second NFT is stored on the second distributed ledger.

4. The electronic device according to claim 3, wherein the second distributed ledger is associated with the first virtual reality platform.

5. The electronic device according to claim 3, wherein
the second distributed ledger is associated with a second virtual reality platform, and
the second virtual reality platform is different from the first virtual reality platform.

6. The electronic device according to claim 5, wherein the user-right associated with the first virtual asset are transferred from the first virtual reality platform to the second virtual reality platform, based on the storage of the second NFT on the second distributed ledger.

7. The electronic device according to claim 1, wherein
the first virtual asset is partially owned by a plurality of users, and
each user of the plurality of users owns a predefined portion of the first virtual asset.

8. The electronic device according to claim 7, wherein the first virtual asset is concurrently used by one or more of the plurality of users on the first virtual reality platform.

9. The electronic device according to claim 1, wherein the circuitry is further configured to:
receive user profile information of the first user from an external party associated with the first virtual reality platform, wherein
the control of the ownership or the usage of the first virtual asset is further based on the received user profile information.

10. The electronic device according to claim 1, wherein the circuitry is further configured to:
determine whether the tracked first virtual asset associated with the first user on the first virtual reality platform is destroyed; and
delete, from the first distributed ledger, each NFT of the set of NFTs associated with the tracked first virtual asset, based on the determination that the tracked first virtual asset is destroyed on the first virtual reality platform.

11. The electronic device according to claim 1, wherein
a semi-fungible token is associated with the tracked first virtual asset on the first virtual reality platform, and
the semi-fungible token corresponds to a predefined number of copies of the first virtual asset on the first virtual reality platform.

12. The electronic device according to claim 1, wherein the first virtual reality platform corresponds to a gaming platform including a set of gaming applications.

13. The electronic device according to claim 12, wherein the circuitry is further configured to:
disassociate the retrieved second NFT, associated with the tracked first virtual asset, from a first gaming application of the set of gaming applications;
associate the retrieved second NFT, associated with the tracked first virtual asset, with a second gaming application of the set of gaming applications;
retrieve, from the first distributed ledger, a third NFT associated with a second virtual asset in the second gaming application;
disassociate the retrieved third NFT, associated with the second virtual asset, from the second gaming application; and
associate the retrieved third NFT, associated with the second virtual asset, with the first gaming application.

14. The electronic device according to claim 13, wherein the third NFT is associated with a second user different from the first user.

15. The electronic device according to claim 13, wherein the third NFT is associated with the first user.

16. The electronic device according to claim 13, wherein the first gaming application is different from the second gaming application.

17. The electronic device according to claim 13, wherein
the first gaming application is same as the second gaming application, and
at least one of a mode, a level, an environment, or a player type associated with the first gaming application is different from the second gaming application.

18. A method, comprising:
in an electronic device:
tracking a first virtual asset associated with a first user on a first virtual reality platform;
receiving metadata associated with the tracked first virtual asset;
creating a first non-fungible token (NFT) associated with the tracked first virtual asset, wherein
the first NFT is created based on a storage of the received metadata to a first distributed ledger associated with the first virtual reality platform;
splitting the created first NFT into a set of NFTs, wherein
each NFT of the set of NFTs is associated with a corresponding user-right associated with the first virtual asset for the first user, and
the set of NFTs is stored on the first distributed ledger;
retrieving, from the set of NFTs, a second NFT associated with the tracked first virtual asset based on a user input from the first user; and
controlling an ownership or a usage of the tracked first virtual asset on the first virtual reality platform, based on the retrieved second NFT.

19. The method according to claim 18, wherein the user-right includes at least one of an ownership right, a modification right, a renting right, a time-share right, or a derivative creation right.

20. A non-transitory computer-readable medium having stored thereon, computer-executable instructions that when executed by an electronic device, causes the electronic device to execute operations, the operations comprising:
tracking a first virtual asset associated with a first user on a first virtual reality platform;
receiving metadata associated with the tracked first virtual asset;
creating a first non-fungible token (NFT) associated with the tracked first virtual asset, wherein
the first NFT is created based on a storage of the received metadata to a first distributed ledger associated with the first virtual reality platform;
splitting the created first NFT into a set of NFTs, wherein
each NFT of the set of NFTs is associated with a corresponding user-right associated with the first virtual asset for the first user, and
the set of NFTs is stored on the first distributed ledger;
retrieving, from the set of NFTs, a second NFT associated with the tracked first virtual asset based on a user input from the first user; and
controlling an ownership or a usage of the tracked first virtual asset on the first virtual reality platform, based on the retrieved second NFT.
